(19) United States
(12) Patent Application Publication
(10) Pub. No.: US 2011/0299301 A1
(43) Pub. Date: Dec. 8, 2011

(54) FIXED-FREQUENCY LLC RESONANT POWER REGULATOR

(75) Inventor: Fuen Huang, Shanghai (CN)

(73) Assignee: Texas Instruments Incorporated, Dallas, TX (US)

(21) Appl. No.: 12/675,458

(22) PCT Filed: Dec. 19, 2008
(86) PCT No.: PCT/CN08/02031

§ 371 Date: Aug. 23, 2011

(51) Int. Cl. H02M 3/335; H02M 7/217

(52) U.S. Cl. 363/17

(57) ABSTRACT

An LLC resonant AC/DC power regulator system (10) includes a transformer (20) comprising a primary inductor and a secondary inductor. An LLC resonant tank (18) is configured to have first and second resonant frequencies. A full-bridge is coupled between first and second voltages and includes a first pair of switches coupled between the first and second voltages and a second pair of switches coupled between the first and second voltages. The LLC resonant tank (18) is coupled between a first node that interconnects the first pair of switches and a second node that interconnects the second pair of switches. The switches (16) are activated and deactivated to generate a resonant current through the LLC resonant tank (18) in response respective switching control signals. The respective switching control signals have fixed frequency and regulated duty-cycle to activate the plurality of switches in a zero voltage switching (ZVS) manner. An output stage (22) is coupled to the secondary inductor and comprising at least one output rectifier (24) that is configured to conduct an output current that is generated in the secondary inductor in response to the resonant current. The out stage (22) generates a rectified output voltage at an output based on the output current.

### TECHNICAL FIELD

This invention relates to electronic circuits, and more particularly to a fixed-frequency LLC resonant power regulator.

### BACKGROUND

There is an increasing demand for power conversion and regulation circuitry to operate with increased efficiency and reduced power dissipation to accommodate the continuous reduction in size of electronic devices. Switching regulators have been implemented as an efficient mechanism for providing a regulated output in power supplies. One such type of regulator is known as a switching regulator or switching power supply, which controls the flow of power to a load by controlling the on and off duty-cycle of one or more switches coupled to the load. Many different classes of switching regulators exist today.

One such type of switching regulator is a resonant power regulator. A resonant power regulator can be configured with a resonant tank that conducts an oscillating resonant current based on a power storage interaction between a capacitor and an inductor, such as in a primary inductor of a transformer. The oscillating resonant current can be generated based on the operation of the switches, and can thus induce a current in a secondary inductor of the transformer. Therefore, an output voltage can be generated based on the output current. Resonant power regulators can be implemented to achieve very low switching loss, and can thus be operated at substantially high switching frequencies.

### SUMMARY

One embodiment of the invention includes an LLC resonant AC/DC power regulator system. The system includes a transformer comprising a primary inductor and a secondary inductor. An LLC resonant tank is configured to have a first second resonant frequencies. A full-bridge is coupled between first and second voltages and includes a first pair of switches coupled between the first and second voltages and a second pair of switches coupled between the first and second voltages. The LLC resonant tank is coupled between a first node that interconnects the first pair of switches and a second node that interconnects the second pair of switches. The switches are activated and deactivated to generate a resonant current through the LLC resonant tank in response respective switching control signals. The respective switching control signals have fixed frequency and regulated duty-cycle to activate the plurality of switches in a zero voltage switching (ZVS) manner. An output stage is coupled to the secondary inductor and comprising at least one output rectifier that is configured to conduct an output current that is generated in the secondary inductor in response to the resonant current. The output stage generates a rectified output voltage at an output based on the output current.

Another embodiment of the invention includes a method for generating an output voltage via an LLC resonant power regulator. The method includes generating a plurality of switching control signals having a fixed frequency and regulated duty-cycle and activating a plurality of switches configured as a full-bridge arrangement in a predetermined sequence in an input stage of the LLC resonant power regulator in response to the plurality of switching signals. The method also includes generating a resonant current through an LLC resonant tank comprising a series connection of a primary inductor of a transformer, a leakage inductor, and a resonant capacitor in response to the activation of the plurality of switches. The method also includes discharging parasitic capacitances associated with the plurality of switches in the predetermined sequence in response to the resonant current to activate the plurality of switches in a ZVS manner. The method also includes generating an output current at a secondary inductor of the transformer, conducting the output current through at least one rectifier in a ZCS manner, and generating an output voltage at an output of the LLC resonant power converter in response to the output current.

Another embodiment of the invention includes an LLC resonant power regulator system. The system includes a switching control stage configured to generate a plurality of switching control signals having a fixed frequency and regulated duty-cycle and an LLC resonant tank comprising a primary inductor of a transformer, a leakage inductor, and a resonant capacitor arranged in series. The system also includes an input stage comprising a plurality of switches arranged as a full-bridge and being controlled by the respective plurality of switching control signals to activate and deactivate in a predetermined sequence to alternately couple and decouple the LLC resonant tank to a high voltage rail and a low voltage rail to generate a resonant current through the LLC resonant tank. The system further includes an output stage comprising a pair of output rectifiers configured to alternately conduct an output current that is generated by a secondary inductor of the transformer in response to the resonant current to generate an output voltage at an output.

### BRIEF DESCRIPTION OF THE DRAWINGS

FIG. 1 illustrates an example of an LLC resonant power regulator system in accordance with an aspect of the invention.

FIG. 2 illustrates another example of an LLC resonant power regulator system in accordance with an aspect of the invention.

FIG. 3 illustrates an example of a metal-oxide semiconductor field-effect transistor (MOSFET) in accordance with an aspect of the invention.

FIG. 4 illustrates an example of a timing diagram in accordance with an aspect of the invention.

FIG. 5 illustrates an example of a method for generating an output voltage via an LLC resonant power regulator in accordance with an aspect of the invention.

### DETAILED DESCRIPTION

The invention relates to electronic circuits, and more particularly to a fixed-frequency LLC resonant power regulator. The LLC resonant power regulator can include a transformer having a primary inductor and a secondary inductor. The primary inductor of the transformer, a leakage inductor, and a resonant capacitor collectively form an LLC resonant tank having a first resonant frequency based on the leakage inductor and the resonant capacitor and a second resonant frequency based on the primary inductor, the leakage inductor, and the resonant capacitor. Therefore, a resonant current is generated in the LLC resonant tank, which thus induces an output current in the secondary inductor to an output stage. The output stage includes a set of output rectifiers, such as diodes, and an output capacitor. The output rectifiers thus alternately conduct the output current to generate an output voltage across the output capacitor and an associated load.

The LLC resonant power regulator can also include an input stage having a full-bridge (i.e., an H-bridge) arrangement of transistors, such as metal-oxide semiconductor field effect transistors (MOSFETs). The full-bridge arrangement can include two interconnecting nodes that are coupled via the LLC resonant tank. The MOSFETs can be driven by a plurality of switching control signals, such as provided from a switching control stage, that have a fixed frequency and a regulated duty-cycle. Therefore, the MOSFETs can be activated and deactivated in a predetermined sequence to generate the LLC resonant current based on alternately coupling each end of the LLC resonant tank to a high voltage rail and a low voltage rail.

The fixed frequency and regulated duty-cycle of the switching control signals, and thus the predetermined sequence of activation of the full-bridge arrangement of the MOSFETs, can be selected such that the MOSFETs are deactivated in a zero voltage switching (ZVS) manner and the output rectifiers are deactivated in a zero current switching (ZCS) manner. Specifically, the MOSFETs can each include a parasitic capacitance and a body-diode. The parasitic capacitance can be alternately charged and discharged by the resonant current through the LLC resonant tank. Upon discharge of the parasitic capacitance by the resonant current, the body-diode can begin to conduct the resonant current. Therefore, the respective MOSFET can be activated subsequent to the conduction of the resonant current in the ZVS manner. In addition, based on changes in current flux through the transistor current in response to oscillation of the resonant current through the LLC resonant tank, the output current can change direction in the output stage. Therefore, the output current can decrease to a magnitude of approximately zero through one of the output rectifiers before being conducted through the other output rectifier, and thus the output rectifiers can be deactivated in the ZCS manner. Accordingly, the fixed-frequency LLC power regulator can be operated with improved input and loading regulation to result in substantially improved efficiency with substantially less electromagnetic interference (EMI) than typical LLC power regulators.

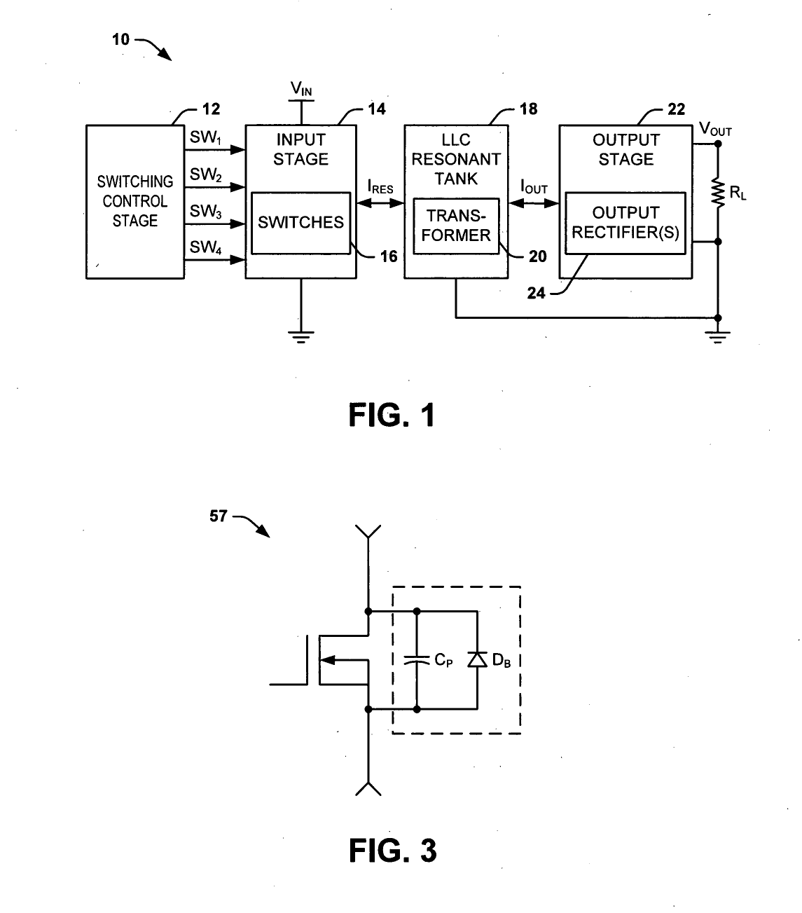

FIG. 1 illustrates an example of an LLC resonant power regulator system 10 in accordance with an aspect of the invention. The LLC resonant power regulator system 10 is configured to generate an output voltage V_{OUT} across a load R_{L} based on an input voltage V_{IN}. The LLC resonant power regulator system 10 can be implemented in a variety of applications, such as in any of a variety of portable electronic devices.

The LLC resonant power regulator system 10 includes a switching control stage 12 configured to generate a plurality of switching control signals. In the example of FIG. 1, the switching control signals are demonstrated as a set of four switching control signals SW₁ through SW₄. The LLC resonant power regulator system 10 also includes an input stage 14 that is interconnected between a high voltage rail, demonstrated as the input voltage V_{IN}, and a low voltage rail, demonstrated as ground. The input stage 14 includes a plurality of switches 16 that are controlled by the switching control signals SW₁ through SW₄. As an example, the switches 16 can be configured in a full- or H-bridge arrangement of switches coupled between voltage rails. For instance, the switches 16 include a first pair of switches interconnected between the rails by a first control node and a second pair of switches interconnected between the rails by a second control node. The control nodes define respective output nodes of the input stage that supply current to an LLC resonant tank 18 according to activation and deactivation of the switches 16.

The LLC resonant tank 18 is configured to conduct a resonant current I_{RES} in response to the operation of the switches 16. In the example of FIG. 1, the LLC resonant tank 18 includes a transformer 20, such that the resonant current I_{RES} can flow through the primary inductor of the transformer 20 as well as, for example, a leakage inductor and a resonant capacitor connected together in series. Thus, the LLC resonant tank 18 can have a first resonant frequency that is defined by the characteristics associated with the leakage inductor and the resonant capacitor, and can have a second resonant frequency that is defined by the characteristics associated with the leakage inductor, the primary inductor, and the resonant capacitor. The first resonant frequency can thus be greater than the second resonant frequency.

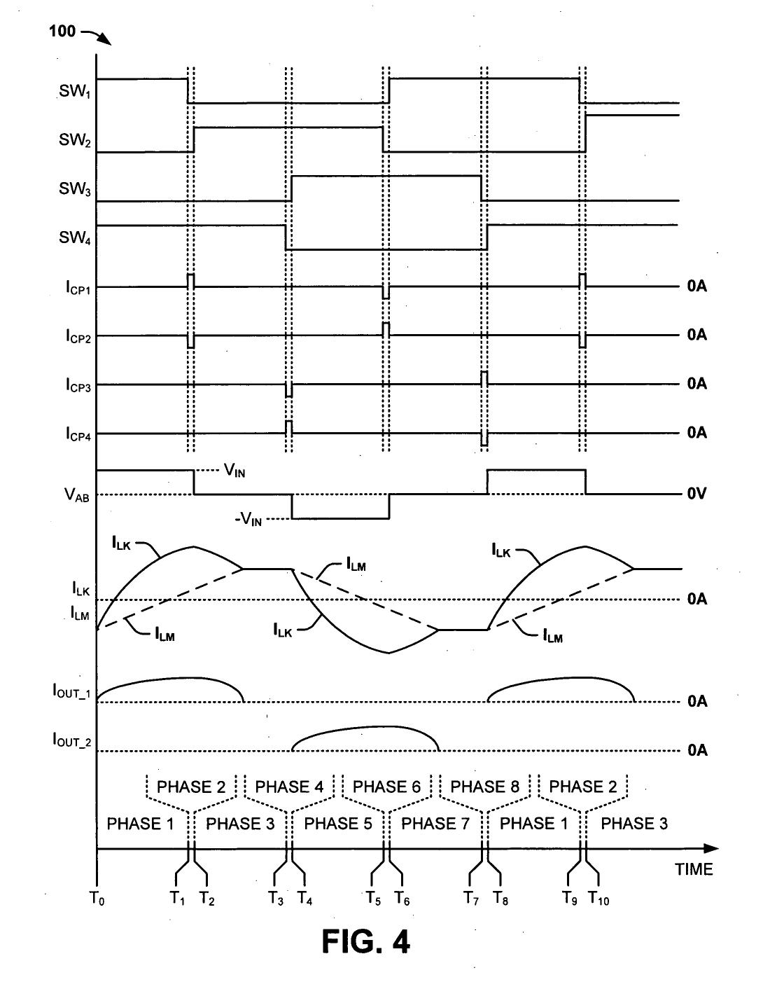

As an example, the LLC resonant tank 18 can be interconnected between the first and second interconnecting control nodes in the input stage 14. The switching control signals SW₁ through SW₄ can have a fixed frequency and a regulated duty-cycle, and can be asserted (i.e., logic-high) and de-asserted (i.e., logic-low) in a predetermined sequence. Therefore, the switches 16 can be operated by the switching control signals SW₁ through SW₄ in the predetermined sequence to alternately couple each end of the LLC resonant tank 18 to the input voltage V_{IN} and to ground. Accordingly, the resonant current I_{RES} can resonate through the LLC resonant tank 18 at the first resonant frequency and the second resonant frequency based on the predetermined activation/deactivation sequence of the switches 16. The predetermined activation/deactivation sequence of the switches 16 can thus define phases of operation of the switches 16 based on the magnitude of the resonant current I_{RES}, as described herein. By controlling the switches as described herein, the voltage across the output nodes of the input stage can be provided as an alternating voltage, such as alternating between V_{IN}, 0 V, and V_{IN}, according to the phase of operation (see, e.g., FIG. 4). It will be appreciated that the voltages will vary depending on the input voltage and the reference voltage, depicted as ground in FIG. 1.

In response to the oscillation of the resonant current I_{RES} through the primary inductor of the transformer 20, a secondary inductor of the transformer 20 generates an output current I_{OUT}. Specifically, the output current I_{OUT} is induced by the resonant current I_{RES} based on a magnetic flux through the core of the transformer 20. The output current I_{OUT} can thus have a flow direction based on the direction of the magnetic flux through the core of the transformer 20 in response to the direction of flow of the resonant current I_{RES}. The output current I_{OUT} is provided to an output stage 22. The output stage 22 includes at least one output rectifier 24 that is configured to rectify the output current I_{OUT} to thus generate the output voltage V_{OUT} across the load R_{L}. As an example, the output rectifier(s) 24 can include a pair of DC rectifiers that are configured to alternately conduct the output current I_{OUT} based on the direction of flow of the output current I_{OUT}.

Based on the fixed frequency and regulated duty-cycle of the switching control signals SW₁ through SW₄, the LLC resonant power regulator system 10 can operate with improved input and loading regulation to result in substantially improved efficiency with substantially less electromagnetic interference (EMI) than typical LLC power regulators. Specifically, the switches 16 and the output rectifier(s) 24 can be soft-switched, such that they are operated in a zero voltage switching (ZVS) and a zero current switching (ZCS) manner, respectively, in response to the predetermined switching sequence of the switches 16 defined by the fixed frequency and regulated duty-cycle of the switching control signals SW₁ through SW₄. For example, the switching control signals SW₁ through SW₄ can have a frequency that is selected to be greater than one or both of the first and second resonant frequencies of the LLC resonant tank 18. Therefore, the switches 16 can operate in the ZVS manner to operate the LLC resonant power regulator system 10 more efficiently and the output rectifier(s) 24 can operate in the ZCS manner to substantially mitigate reverse recovery oscillation via the transformer 20.

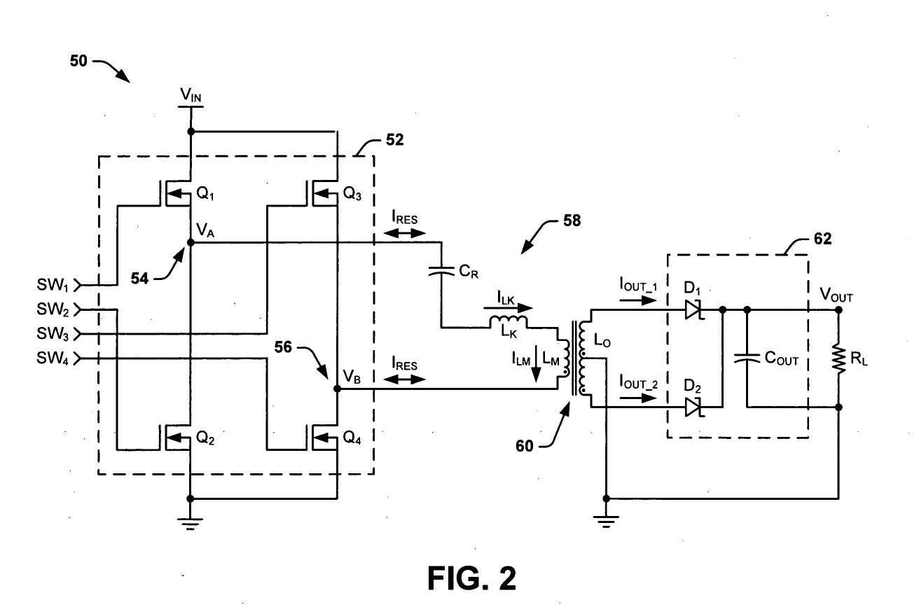

FIG. 2 illustrates another example of an LLC resonant power regulator system 50 in accordance with an aspect of the invention. Similar to as described above in the example of FIG. 1, the LLC resonant power regulator system 50 is configured to generate an output voltage V_{OUT} across a load R_{L} based on an input voltage V_{IN}. As an example, the input voltage V_{IN} can be approximately 350 to 400 VDC to result in an output voltage V_{OUT} of approximately 51 VDC.

The LLC resonant power regulator system 50 includes an input stage 52 that is interconnected between a high voltage rail, demonstrated as the input voltage V_{IN}, and a low voltage rail, demonstrated as ground. The input stage 52 includes a plurality of switches, demonstrated in the example of FIG. 2 as metal-oxide semiconductor field effect transistors (MOSFETs) Q₁, Q₂, Q₃, and Q₄ that are controlled, respectively, by switching control signals SW₁, SW₂, SW₃, and SW₄. In the example of FIG. 2, the MOSFET Q₁ is coupled to the input voltage V_{IN}, the MOSFET Q₂ is coupled to ground, and the MOSFETs Q₁ and Q₂ are interconnected in series by a control node 54 having a voltage V_{A}. Similarly, the MOSFET Q₃ is coupled to the input voltage V_{IN}, the MOSFET Q₄ is coupled to ground, and the MOSFETs Q₃ and Q₄ are interconnected in series by a control node 56 having a voltage V_{B}. Therefore, the MOSFETs Q₁ through Q₄ are arranged as a full-bridge.

FIG. 3 illustrates an example of a MOSFET 57 in accordance with an aspect of the invention. As an example, the MOSFET 57 can correspond to any one of the MOSFETs Q₁ through Q₄ in the input stage 52 of the example of FIG. 2. In the example of FIG. 3, the MOSFET 57 includes a parasitic capacitance C_{P} and a body-diode D_{B} that are coupled in parallel with the MOSFET 57 between the drain and source of the MOSFET 57. The parasitic capacitance C_{P} and the body-diode D_{B} can result from fabrication of the MOSFET 57, such that the parasitic capacitance C_{P} and the body-diode D_{B} are integral to the design of the MOSFET 57. As described herein, the parasitic capacitance C_{P} and the body-diode D_{B}, along with the interaction of the switching signals SW₁ through SW₄ with the MOSFETs Q₁ through Q₄, can be implemented to switch the MOSFETs Q₁ through Q₄ in the ZVS manner.

Referring back to the example of FIG. 2, the LLC resonant power regulator system 50 also includes an LLC resonant tank 58 configured to conduct a resonant current I_{RES} in response to the activation and deactivation of the MOSFETs Q₁ through Q₄. In the example of FIG. 2, the LLC resonant tank 58 includes a primary inductor L_{M} of a transformer 60, a leakage inductor L_{K}, and a resonant capacitor C_{R} that are coupled in series between the first control node 54 and the second control node 56. Therefore, the resonant current I_{RES} can flow and resonate through the LLC resonant tank 58 in response to the activation and deactivation of the MOSFETs Q₁ through Q₄. The LLC resonant tank 58 has a first resonant frequency fr1 that is defined by the characteristics associated with the leakage inductor L_{K} and the resonant capacitor C_{R} as follows:

$$fr 1 = \frac{1}{2 * π * \sqrt{{L}_{K} * {C}_{R}}} \qquad Equation 1$$

Where: L_{K} is the inductance of the leakage inductor L_{K}; and
   C_{R} is the capacitance of the resonant capacitor C_{R}.
      The LLC resonant tank 58 also has a second resonant frequency fr2 that is defined by the characteristics associated with the leakage inductor L_{K}, the primary inductor L_{M}, and the resonant capacitor C_{R} as follows:

$$fr 2 = \frac{1}{2 * π * \sqrt{( {L}_{K} + {L}_{M} ) * {C}_{R}}} \qquad Equation 2$$

Where: L_{M} is the inductance of the primary inductor L_{M}.
   Therefore, Equations 1 and 2 demonstrate that the first resonant frequency fr1 is greater than the second resonant frequency fr2.

As described above, the resonant current I_{RES} is generated based on the switching of the MOSFETs Q₁ through Q₄. The switching control signals SW₁ through SW₄ can have a fixed frequency and a regulated duty-cycle, and can be asserted and de-asserted in a predetermined sequence. Therefore, the MOSFETs Q₁ through Q₄ can be operated by the switching control signals SW₁ through SW₄ in the predetermined sequence to alternately couple each end of the LLC resonant tank 58 to the input voltage V_{IN} and to ground, such that the difference between the voltage V_{A} and the voltage V_{B} can be periodically switched between zero, a positive magnitude of the input voltage V_{IN} and a negative magnitude of the input voltage V_{IN}. Accordingly, the resonant current I_{RES} can alternate at resonating through the LLC resonant tank 58 at each of the first resonant frequency fr1 and the second resonant frequency fr2 based on the predetermined activation/deactivation sequence of the MOSFETs Q₁ through Q₄.

In the example of FIG. 2, the resonant current I_{RES} is demonstrated as including a current I_{LK} flowing through the leakage inductor L_{K} and a current I_{LM} flowing through the primary inductor L_{M}. As demonstrated in the example of FIG. 2, the transformer 60 includes a secondary inductor L_{O} that is coupled to the load R_{L}. Therefore, the loading of the secondary inductor L_{O} results in variation of the current I_{LM} relative to the current I_{LK}. Accordingly, as described herein, the current I_{LM} is a magnetizing current that is associated with a reactance of the primary inductor L_{M} based on the magnetic flux through the core of the transformer 60 lagging the induced EMF by approximately 90°. Specifically, as described above, the LLC resonant tank 58 has a first resonant frequency fr1 and a second resonant frequency fr2. As described herein, based on the predetermined sequence of the switching of the MOSFETs Q₁ through Q₄, the current I_{LM} and the current I_{LK} can be unequal when the resonant current I_{RES} resonates at the first resonant frequency fr1. Additionally, the current I_{LM} and the current I_{LK} can be equal when the resonant current I_{RES} resonates at the second resonant frequency fr2.

In response to the oscillation of the resonant current I_{RES} through the primary inductor L_{M} of the transformer 60, a secondary inductor L_{O} of the transformer 60 generates an output current I_{OUT} that is induced in the secondary inductor L_{O} based on a magnetic flux through the core of the transformer 60. The output current L_{OUT} has a direction of current flow that is based on the direction of the magnetic flux through the core of the transformer 60 in response to the direction of flow of the resonant current I_{RES}. In the example of FIG. 2, each end of the secondary inductor L_{O} is coupled to an output stage 62 that includes a first output diode D₁ and a second output diode D₂. The output diodes D₁ and D₂ are configured to rectify the output current I_{OUT}. Therefore, the output current I_{OUT} is provided as an output current I_{OUT}_{_{—}}₁ through the output diode D₁ or as an output current I_{OUT}_{_{—}}₂ through the output diode D₂, depending on the direction of current flow of the output current I_{OUT} through the secondary inductor L_{O}. Thus, the output diodes D₁ and D₂ alternately conduct the output currents I_{OUT}_{_{—}}₁ and I_{OUT}_{_{—}}₂, respectively, based on the direction of current flow through the secondary inductor L_{O}. In the example of FIG. 2, the output currents I_{OUT}_{_{—}}₁ and I_{OUT}_{_{—}}₂ are conducted from a ground connection that is electrically isolated from the ground connection that is coupled to the input stage 52. It is to be understood, however, that electrical isolation of the ground connections may not be necessary, as dictated by the power-providing application. The output stage 62 also includes an output capacitor C_{O} coupled in parallel with the load R_{L}. The output currents I_{OUT} and I_{OUT}_{_{—}}₂, as well as the output capacitor C_{O}, are thus configured to maintain the magnitude of the output voltage V_{OUT} across the load R_{L}.

Similar to as described above in the example of FIG. 1, based on the fixed frequency and regulated duty-cycle of the switching control signals SW₁ through SW₄, the LLC resonant power regulator system 50 can operate with improved input and loading regulation to result in substantially improved efficiency with substantially less EMI than typical LLC power regulators. The predetermined sequence of the switching control signals SW₁ through SW₄ results in an operation cycle of the MOSFETs Q₁ through Q₄ that includes charging the respective parasitic capacitance, free-wheeling the respective body-diode, discharging the respective parasitic capacitance, and free-wheeling the respective body-diode again. Therefore, the MOSFETs Q₁ through Q₄ can all be activated in the ZVS manner based on the known operation cycle. As a result of the alternation of the difference between the voltages V_{A} and V_{B} in response to the fixed-frequency and regulated duty-cycle control of the MOSFETs Q₁ through Q₄, the LLC resonant power regulator system 50 acts as an AC/DC power regulator. In addition, based on the known oscillation of the resonant current I_{RES} through the LLC resonant tank 58, the magnitudes of the output currents I_{OUT}_{_{—}}₁ and I_{OUT}_{_{—}}₂ can be controlled. Thus, the output diodes D₁ and D₂ can each be deactivated in the ZCS manner. Accordingly, the MOSFETs Q₁ through Q₄ can operate in the ZVS manner to operate the LLC resonant power regulator system 50 more efficiently and the output diodes D₁ and D₂ can operate in the ZCS manner to substantially mitigate reverse recovery oscillation.

It is to be understood that the LLC resonant power regulator system 50 is not intended to be limited to the example of FIG. 2. For example, the LLC resonant power regulator system 50 is not limited to implementing MOSFETs, but could instead use one of a variety of other types of FETs instead of the MOSFETs Q₁ through Q₄. As another example, the resonant capacitor C_{R} is not intended to be limited to being coupled between the leakage inductor L_{K} and the first control node 54, but could instead be coupled between the primary inductor L_{M} and the second control node 56. In addition, in the example of FIG. 2, the first and second diodes D₁ and D₂ are demonstrated as Schottky diodes. However, it is to be understood that the first and second diodes D₁ and D₂ are not limited to implementation as Schottky diodes. Accordingly, those skilled in the art will understand and appreciate that the LLC resonant power regulator system 50 can be configured in any of a variety of ways based on the teachings herein.

FIG. 4 illustrates an example of a timing diagram 100 in accordance with an aspect of the invention. The timing diagram 100 can correspond to the LLC resonant power regulator system 50 in the example of FIG. 2. Therefore, reference is to be made to the example of FIG. 2 in the following description of the example of FIG. 4.

The timing diagram 100 demonstrates an example of the predetermined sequence of the switching control signals SW₁ through SW₄ over time. Specifically, the predetermined sequence is demonstrated as a sequence of eight phases, demonstrated in the example of FIG. 4 as PHASE 1 through PHASE 8. The predetermined sequence begins at a time T₀ in PHASE 1 which continues through a time T₁. Thus, the LLC resonant power regulator system 50 operates in PHASE 1 from the time T₀ to the time T₁. Similarly, the LLC resonant power regulator system 50 operates in PHASE 2 from the time T₁ to a time T₂, in PHASE 3 from the time T₂ to a time T₃, in PHASE 4 from the time T₃ to a time T₄, in PHASE 5 from the time T₄ to a time T₅, in PHASE 6 from the time T₅ to a time T₆, in PHASE 7 from the time T₆ to a time T₇, and in PHASE 8 from the time T₇ to a time T₈. Therefore, the example of FIG. 4 demonstrates diagrammatically that PHASES 2, 4, 6, and 8 are significantly shorter than PHASES 1, 3, 5, and 7. However, it is to be understood that the demonstrated phases are not necessarily demonstrated to scale. For example, PHASES 1, 3, 5, and 7 can be substantially longer than as demonstrated in the example of FIG. 4 relative to PHASES 2, 4, 6, and 8. In addition, the switching control signals SW₁ through SW₄ are demonstrated as logic-high to correspond to activation of the respective MOSFETs Q₁ through Q₄. However, it is to be understood that MOSFETs Q₁ through Q₄ could instead be activated by logic-low states of the switching control signals SW₁ through SW₄.

In PHASE 1, the switching control signals SW₁ and SW₄ are demonstrated as asserted and the switching control signals SW₂ and SW₃ are demonstrated as de-asserted. Therefore, the MOSFETs Q₁ and Q₄ are activated and the MOSFETs Q₂ and Q₃ are deactivated in PHASE 1. Thus, a voltage V_{AB} (i.e., the difference between the voltage V_{A} and the voltage V_{B} at the respective control nodes 54 and 56) is positive in PHASE 1. The current I_{LK} through the leakage inductor L_{K} increases substantially sinusoidally from a negative magnitude (i.e., relative to as demonstrated in the example of FIG. 2) while the current I_{LM} through the primary inductor L_{M} increases substantially linearly from approximately the same magnitude at the time T₀, such as based on a constant voltage across the primary inductor L_{M}. As an example, the transistor 60 can have a number of turns of the primary and secondary windings that is approximately a ratio of 94:13. Therefore, the constant voltage across the primary inductor L_{M} can be approximately equal to (V_{OUT}*94/13). During PHASE 1 each of the currents I_{LK} and I_{LM} reverse direction, and thus become positive. The resonant current I_{RES} is therefore resonating at the first resonant frequency fr1 during PHASE 1. In addition, based on the direction of the magnetic flux through the transformer 60, the output current I_{OUT}_{_{—}}₁ increases from a magnitude of approximately zero at the time T₀.

At the time T₁, at the beginning of PHASE 2, the switching control signal SW₁ is de-asserted to deactivate the MOSFET Q₁. However, the currents L_{K} and L_{M} continue to flow. In response, the parasitic capacitance C_{P1} of the MOSFET Q₁ is charged and a parasitic capacitance C_{P2} of the MOSFET Q₂ is discharged, demonstrated in the example of FIG. 4 as a positive current pulse I_{CP1} and a negative current pulse I_{CP2} during PHASE 2. Upon discharge of the parasitic capacitance C_{P2} of the MOSFET Q₂, the body-diode D_{B2} of the MOSFET Q₂ can begin to conduct the resonant current I_{RES} during PHASE 2. The conduction of the resonant current I_{RES} through the body-diode D_{B2} of the MOSFET Q₂ results in a drain-source voltage V_{DS} across the MOSFET Q₂ of approximately 0 volts. Accordingly, at the time T₂, the switching control signal SW₂ is asserted to activate the MOSFET Q₂ in the ZVS manner.

In PHASE 3, upon activation of the MOSFET Q₂, the voltage V_{AB} becomes approximately equal to zero. The current I_{LK} through the leakage inductor L_{K} thus begins to decrease. In response, the output current I_{OUT}_{_{—}}₁ likewise begins to decrease. The current I_{LM} through the primary inductor L_{M}, however, continues to increase substantially linearly. Upon the current I_{LK} and I_{LM} becoming approximately equal, the currents I_{LK} and I_{LM} become substantially constant and the output current I_{OUT}_{_{—}}₁ decreases to a magnitude of approximately zero. Therefore, the resonant current I_{RES} begins to resonate at the second resonant frequency fr2. In addition, because the resonant current I_{RES} resonates at the second resonant frequency fr2, the magnetic flux through the core of the transformer 60 is approximately zero, resulting in no induced current in the secondary inductor L_{O} of the transformer 60. Therefore, the output capacitor COUT discharges to maintain the output voltage V_{OUT}. At the end of PHASE 3, the voltage in the resonant capacitor C_{R} reverses due to the resonance of the LLC resonance tank 58.

At the time T₃, at the beginning of PHASE 4, the switching control signal SW₄ is de-asserted to deactivate the MOSFET Q₄. However, the resonant current I_{RES} continues to flow. In response, a parasitic capacitance C_{P4} of the MOSFET Q₄ is charged and a parasitic capacitance C_{P3} of the MOSFET Q₃ is discharged, demonstrated in the example of FIG. 4 as a positive current pulse I_{CP4} and a negative current pulse I_{CP3} during PHASE 4. Upon discharge of the parasitic capacitance C_{P3} of the MOSFET Q₃, the body-diode D_{B3} of the MOSFET Q₃ can begin to conduct the resonant current I_{RES} during PHASE 4. The conduction of the resonant current I_{RES} through the body-diode D_{B3} of the MOSFET Q₃ results in a drain-source voltage V_{DS} across the MOSFET Q₃ of approximately 0 volts. Accordingly, at the time T₄, the switching control signal SW₃ is asserted to activate the MOSFET Q₃ in the ZVS manner.

In PHASE 5, upon activation of the MOSFET Q₃, the voltage V_{AB} becomes negative. Thus, the resonant current I_{RES} begins to resonate at the first resonant frequency fr1 again. Specifically, the current I_{LK} through the leakage inductor L_{K} begins to decrease substantially sinusoidally from the positive magnitude while the current I_{LM} through the primary inductor L_{M} begins to decrease substantially linearly from approximately the same magnitude at the time T₄, such as based on a constant voltage across the primary inductor L_{M}. During PHASE 5 each of the currents I_{LK} and I_{LM} reverse direction, and thus become positive. In addition, based on the reversed direction of the magnetic flux through the transformer 60, the output current I_{OUT}_{_{—}}₂ increases from a magnitude of approximately zero at the time T₄.

At the time T₅, at the beginning of PHASE 6, the switching control signal SW₂ is de-asserted to deactivate the MOSFET Q₂. However, the currents L_{K} and L_{M} continue to flow. In response, a parasitic capacitance C_{P2} of the MOSFET Q₂ is charged and a parasitic capacitance C_{P1} of the MOSFET Q is discharged, demonstrated in the example of FIG. 4 as a positive current pulse I_{CP2} and a negative current pulse I_{CP1} during PHASE 6. Upon discharge of the parasitic capacitance C_{P1} of the MOSFET Q₁, the body-diode D_{B1} of the MOSFET Q₁ can begin to conduct the resonant current I_{RES} during PHASE 6. The conduction of the resonant current I_{RES} through the body-diode D_{B1} of the MOSFET Q₁ results in a drain-source voltage V_{DS} across the MOSFET Q₁ of approximately 0 volts. Accordingly, at the time T₆, the switching control signal SW₁ is asserted to activate the MOSFET Q₁ in the ZVS manner.

In PHASE 7, upon activation of the MOSFET Q₁, the voltage V_{AB} becomes approximately equal to zero. The current I_{LK} through the leakage inductor L_{K} thus begins to increase. In response, the output current I_{OUT}_{_{—}}₂ likewise begins to decrease. The current I_{LM} through the primary inductor L_{M}, however, continues to decrease substantially linearly. Upon the current I_{LK} and I_{LM} becoming approximately equal, the currents I_{LK} and I_{LM} become substantially constant and the output current I_{OUT}_{_{—}}₂ decreases to a magnitude of approximately zero. Therefore, the resonant current I_{RES} again begins to resonate at the second resonant frequency fr2. In addition, because the resonant current I_{RES} resonates at the second resonant frequency fr2, the magnetic flux through the core of the transformer 60 is approximately zero, resulting in no induced current in the secondary inductor L_{O} of the transformer 60. Therefore, the output capacitor COUT again discharges to maintain the output voltage V_{OUT}. At the end of PHASE 7, the voltage in the resonant capacitor C_{R} again reverses due to the resonance of the LLC resonance tank 58.

At the time T₇, at the beginning of PHASE 8, the switching control signal SW₃ is de-asserted to deactivate the MOSFET Q₃. However, the resonant current I_{RES} continues to flow. In response, a parasitic capacitance C_{P3} of the MOSFET Q₃ is charged and a parasitic capacitance C_{P4} of the MOSFET Q₄ is discharged, demonstrated in the example of FIG. 4 as a positive current pulse I_{CP3} and a negative current pulse I_{CP4} during PHASE 8. Upon discharge of the parasitic capacitance C_{P4} of the MOSFET Q₄, the body-diode D_{B4} of the MOSFET Q₄ can begin to conduct the resonant current I_{RES} during PHASE 8. The conduction of the resonant current I_{RES} through the body-diode D_{B4} of the MOSFET Q₄ results in a drain-source voltage V_{DS} across the MOSFET Q₄ of approximately 0 volts. Accordingly, at the time T₈, the switching control signal SW₄ is asserted to activate the MOSFET Q₄ in the ZVS manner. Therefore, the predetermined sequence repeats beginning at the time T₈, at which the LLC resonant power regulator system 50 again enters PHASE 1.

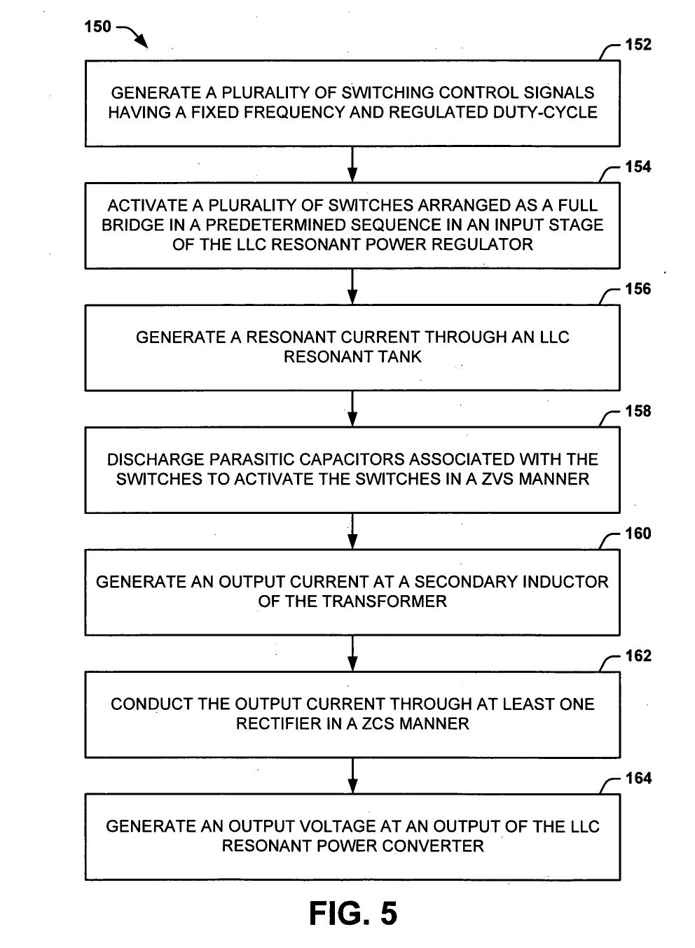

In view of the foregoing structural and functional features described above, certain methods will be better appreciated with reference to FIG. 5. It is to be understood and appreciated that the illustrated actions, in other embodiments, may occur in different orders and/or concurrently with other actions. Moreover, not all illustrated features may be required to implement a method.

FIG. 5 illustrates an example of a method 150 for generating an output voltage via an LLC resonant power regulator in accordance with an aspect of the invention. At 152, a plurality of switching control signals having a fixed frequency and a regulated duty-cycle are generated. The switching control signals can be generated from a switching control stage, or any of a variety of other types of processing or clock generating components. At 154, a plurality of switches arranged as a full-bridge are activated in a predetermined sequence in an input stage of the LLC resonant power regulator in response to the plurality of switching signals. The predetermined sequence can define a plurality (e.g., eight) of phases of operation. The switches can be configured as MOSFET switches, and the full-bridge can have first and second control nodes.

At 156, a resonant current is generated through an LLC resonant tank in response to the activation of the plurality of switches. The LLC resonant tank can include a series connection of a primary inductor of a transformer, a leakage inductor, and a resonant capacitor. The resonant current can include a leakage current through the leakage inductor and a magnetizing current that is associated with the reactance of the primary inductor. At 158, parasitic capacitances associated with the plurality of switches are discharged in the predetermined sequence in response to the resonant current to activate the plurality of switches in a ZVS manner. Each of the switches can also include a body-diode that conducts the resonant current just prior to the activation of the switch. At 160, an output current is generated at a secondary inductor of the transformer. The output current can be induced by the magnetic flux that results from the resonant current flow through the primary inductor.

At 162, the output current is conducted through at least one rectifier in a ZCS manner. The at least one rectifier can include a pair of output diodes that alternately conduct the output current. The direction of the current flow of the output current can change in the secondary inductor based on changes in the magnetic flux through the core. Thus, the current through one of the diodes can decrease to a magnitude of zero before beginning to conduct through the other diode. At 164, an output voltage is generated at an output of the LLC resonant power converter in response to the output current. The output voltage can be maintained by an output capacitor when the magnitude of the output current is approximately zero.

What have been described above are examples of the invention. It is, of course, not possible to describe every conceivable combination of components or methodologies for purposes of describing the invention, but one of ordinary skill in the art will recognize that many further combinations and permutations of the invention are possible. Accordingly, the invention is intended to embrace all such alterations, modifications, and variations that fall within the scope of this application, including the appended claims.

What is claimed is:

1. An LLC resonant AC/DC power regulator system comprising:
a transformer comprising a primary inductor and a secondary inductor;
an LLC resonant tank comprising a resonant capacitor and a leakage inductor coupled in series with the primary inductor, the LLC resonant tank being configured to have a first resonant frequency and a second resonant frequency;
an input stage comprising a full-bridge coupled between an input voltage and a reference voltage, the full-bridge comprising a first pair of switches coupled between the input voltage and the reference voltage and a second pair of switches coupled between the input voltage and the reference voltage, the LLC resonant tank interconnected between a first node that interconnects the first pair of switches and a second node that interconnects the second pair of switches, the switches being activated and deactivated to generate a resonant current through the LLC resonant tank in response respective switching control signals, the respective switching control signals having fixed frequency and regulated duty-cycle control to operate the switches of the full-bridge in a zero voltage switching (ZVS) manner; and
an output stage coupled to the secondary inductor and comprising at least one output rectifier that is configured to conduct an output current that is generated in the secondary inductor in response to the resonant current, the output stage generating a rectified output voltage at an output based on the output current.

2. The system of claim 1, wherein the switches of the full bridge are configured as metal-oxide semiconductor field-effect transistors (MOSFETs).

3. The system of claim 1, wherein the fixed frequency and fixed duty cycle control defines an operation cycle of the switches comprising a plurality of phases and wherein each of the switches comprises a parasitic capacitance, and wherein every other one of the plurality of phases of operation defines a period of charging and discharging parasitic capacitances of respective switches in one of the first and second pairs of the switches as a result of a magnitude of the resonant current flowing through the leakage inductor.

4. The system of claim 3, wherein each of the switches in the full-bridge comprises a body-diode, and wherein the respective switch of the one of the first and second pairs of the switches that discharges the parasitic capacitance conducts the resonant current through the respective body-diode at a time just prior to its activation, such that the respective switch activates in the ZVS manner.

5. The system of claim 1, wherein the at least one output rectifier comprises a first diode and a second diode that each have a cathode coupled to the output and an anode coupled to opposite terminals of secondary inductor, respectively, the first diode and the second diode being configured to alternately conduct the output current to provide the rectified output voltage at the output, the first diode and the second diode alternately deactivating in a zero current switching (ZCS) manner depending on a magnitude of the output current.

6. The system of claim 5, wherein the output stage further comprises an output capacitor and wherein the resonant current comprises a leakage resonant current associated with the leakage inductor and a magnetizing current associated with a reactance of the primary inductor, the leakage resonant current and the magnetizing current having a substantially equal magnitude that occurs periodically based on the fixed frequency and regulated duty-cycle of the switching control signals.

7. The system of claim 6, wherein, subsequent to the output current through one of the first diode and the second diode being decreased to the substantially zero magnitude, the output current begins to increase through the other of the first diode and the second diode in response to a change in magnetic flux through the primary inductor, such that the first diode and the second diode operate in the ZCS manner.

8. The system of claim 1, wherein the switching control signals have a fixed-frequency that is selected to be greater than at least one of the first resonant frequency and the second resonant frequency of the LLC resonant tank.

9. The system of claim 1, wherein the first node has a first voltage and the second node has a second voltage and wherein the fixed frequency and fixed duty cycle control defines an operation cycle of the switches comprising a plurality of phases, wherein a difference between the first voltage and the second voltage switches between zero, a positive magnitude of the input voltage of the LLC resonant AC/DC power regulator system, and a negative magnitude of the LLC resonant AC/DC power regulator system depending on the phase of the operation cycle.

10. The system of claim 1, wherein the fixed frequency and fixed duty cycle control defines a sequential operation cycle of the switches having a plurality of phases, and wherein every other one of the plurality of phases in the operation cycle controls the switches to maintain the resonant current at one of the first resonant frequency and the second resonant frequency.

11. An LLC resonant power regulator system comprising:
a switching control stage configured to generate a plurality of switching control signals having a substantially fixed frequency and regulated duty-cycle;
an LLC resonant tank comprising a primary inductor of a transformer, a leakage inductor, and a resonant capacitor arranged in series;
an input stage comprising a plurality of switches arranged as a full-bridge and being controlled by the respective plurality of switching control signals to activate and deactivate in a predetermined sequence to provide an alternating voltage potential across output nodes thereof, the LLC resonant tank being coupled the output nodes of the input stage, the LLC resonant tank generating a resonant current through the LLC resonant tank according to the activation and deactivation of the plurality of switches; and
an output stage comprising at least one rectifier configured to alternately conduct an output current that is generated by a secondary inductor of the transformer in response to the resonant current to provide a rectified output voltage at an output thereof.

12. The system of claim 11, wherein the at least one rectifier comprises a pair of output diodes, the output current flowing through one of the pair of output diodes based on a direction of current flow of the output current through the secondary inductor of the transformer in response to the resonant current flowing through the LLC resonant tank, such that the output current decreases to a magnitude of approximately zero through one of the pair of output diodes before being conducted through the other of the pair of output diodes to deactivate the pair of output diodes in a zero current switching manner.

13. The system of claim 11, wherein the plurality of switches each comprise a parasitic capacitance and a body-diode, the parasitic capacitance being charged and discharged by the resonant current and, upon the parasitic capacitance being discharged, the body-diode is configured to conduct the resonant current prior to the respective switch of the plurality of switches activating such that the switches operate in a zero voltage switching manner.

14. A method for generating an output voltage via an LLC resonant power regulator, the method comprising:
generating a plurality of switching control signals having a substantially fixed frequency and regulated duty-cycle;
controlling switches of a full-bridge circuit in a predetermined sequence in response to the plurality of switching control signals to provide an alternating voltage potential across output nodes of the full-bridge circuit, the full-bridge circuit being connected between an input voltage and a reference voltage;
generating a resonant current through an LLC resonant tank in response to the alternating voltage potential, the LLC resonant tank comprising a series connection of a primary inductor of a transformer, a leakage inductor, and a resonant capacitor coupled between the output nodes of the full-bridge circuit;
discharging a parasitic capacitor associated with each of the switches in the predetermined sequence in response to the resonant current to facilitate operating the switches in a zero voltage switching (ZVS) manner;
generating an output current at a secondary inductor of the transformer; and
conducting the output current through at least one rectifier in a zero current switching (ZCS) manner to provide a corresponding output voltage at an output of the LLC resonant power regulator.

15. The method of claim 14, wherein conducting the output current comprises alternately conducting the output current through a first diode and a second diode, the first diode and the second diode each having a cathode coupled to the output and an anode coupled to opposite terminals of secondary inductor, respectively.

16. The method of claim 15, wherein generating the output voltage comprises:
changing a magnetic flux through the primary inductor based on the predetermined sequence of the switches;
decreasing the output current through one of the first diode and the second diode to a magnitude of approximately zero in response to a change in the magnetic flux, such that the one of the first diode and the second diode deactivates in the ZCS manner;
discharging an output capacitor to maintain the output voltage at the output; and
increasing the magnitude of the output current through the other of the first diode and the second diode.

17. The method of claim 16, wherein changing the magnetic flux through the primary inductor comprises switching the LLC resonant tank between a first resonant frequency that is set according to the leakage inductor and the resonant capacitor and a second resonant frequency that is set according to the leakage inductor, the primary inductor, and the resonant capacitor.

18. The method of claim 14, wherein the predetermined sequence defines an operation cycle for the LLC resonant power regulator having a plurality of phases, and
wherein the alternating voltage potential varies between a first voltage corresponding to a difference between the input voltage and the reference voltage, zero volts, and a second voltage that is a negative of the first voltage according to the phase of the operation cycle.

19. The method of claim 14, further comprising conducting the resonant current through a body-diode of a given one of the switches in response to discharging the parasitic capacitor associated with the given one of the switches.

20. The method of claim 19, further comprising activating the given one of the switches while conducting the resonant current through the body-diode thereof such the given one of the switches activates in the ZVS manner.
